(19) United States
(12) Patent Application Publication
(10) Pub. No.: US 2018/0082349 A1
(43) Pub. Date: Mar. 22, 2018

(54) DEVICE FOR PROVIDING HEALTH INFORMATION AND ADVICE TO SHOPPERS

(71) Applicant: ACH Food Companies, Inc., Cordova, TN (US)

(72) Inventors: Luis Viera, San Juan, PR (US); Arturo Perez, San Juan, PR (US); Vanessa Fernandez, Guaynabo, PR (US)

(21) Appl. No.: 15/269,198

(22) Filed: Sep. 19, 2016

(51) Int. Cl. G06Q 30/06; H04W 4/00; H04W 4/04

(52) U.S. Cl. CPC G06Q 30/0631; H04W 4/008; H04W 4/04; G06F 3/04847; G06Q 30/0639; G06Q 30/0641; G06Q 30/0633

(57) ABSTRACT

A product assistant device may attach to a shopping cart or other baggage cart and provide information and guidance on products within a retail space. The assistant device may provide physiological information from sensors such as heart rate, blood pressure, or other non-invasively measured characteristics via a display. As the device moves through a retail space it may wirelessly communicate with beacons placed around the retail space in order to provide location specific information on products that may be nearby. Information may include pictures, health impact, selection guides, recipes, and directions to other locations within the retail space where other products and beacons may be located. Using such a system, a number of beacons and corresponding information displays may be used to guide a shopper through the store and introduce them to healthier food choices.

### FIELD

The disclosed technology pertains to an automated system for providing a user with guidance and information while at a retail location.

### BACKGROUND

It is difficult to know which items are healthy for your heart while grocery shopping. Shoppers make decisions based on impulse, taste or routine rather than information about health benefits in an organic shopping context. The process of selecting food or other products in a grocery store is also influenced by external conditions that determine our trajectory in a supermarket. The route that the consumer follows is directly linked to the choices they make, which can deter them from making healthy ones. As a result, something as simple as colorful packaging, eye-level product placement, or cart storage location can determine the path that a shopper takes in a retail location and can lead them directly to areas where they will make unhealthy shopping choices when they first arrive at a retail location. By the time the same shopper reaches an area of the store with fresh produce, vegetables, or healthy meats, their shopping choices may begin to be influenced by their previous choices in an effort to be cost conscious or not buy more food than necessary.

An additional factor that influences whether shoppers make healthy shopping choices is that many adults either are not well informed on health matters, or may even be misinformed. While many people worry about their weight or health, they often do not know what a healthy weight, or a healthy heart rate actually is. Other adults may consider themselves a healthy weight or may think that they have a healthy heart, while in fact they may be overweight, underweight, or present other characteristics that may influence heart health.

This combination of lack of information, misinformation, and bombardment by product messages and aggressive marketing can result in shoppers who are trained to make unhealthy choices without realizing it, even when they consciously believe they live a healthy lifestyle. While some retailers may address this by providing helpful information in the form of printed posters or signage placed in key areas, or by providing printed flyers at an entrance, this is a costly method of providing information that can quickly become outdated, is difficult to update, and relies on printed materials that easily show wear and create waste.

What is needed, therefore, is an improved system for providing shoppers at a retail location with information, guidance, and advice in making healthier shopping choices.

### BRIEF DESCRIPTION OF THE DRAWINGS

The drawings and detailed description that follow are intended to be merely illustrative and are not intended to limit the scope of the invention as contemplated by the inventors.

FIG. 1 is a combined perspective and schematic view of an exemplary device for providing information and guidance to a shopper.

FIG. 2 is a side elevation view of an exemplary device for providing information and guidance to a shopper.

FIG. 3 is a flowchart of a set of steps that could be performed using a device such as that shown in FIG. 1 to prepare the device for a user.

FIG. 4 is a flowchart of a set of steps that could be performed using a device such as that shown in FIG. 1 to provide location-specific information and guidance to a user.

FIG. 5 is a schematic view of an exemplary system for providing information and guidance to a user.

FIG. 6 is a schematic view of an exemplary area configured to support a system such as that shown in FIG. 5.

FIG. 7 is a simulated screenshot of an interface that could be displayed by a device such as that shown in FIG. 1 to provide information to a user.

FIG. 8 is a simulated screenshot of an interface that could be displayed by a device such as that shown in FIG. 1 to provide a user an option for additional information.

FIG. 9 is a simulated screenshot of an interface that could be displayed by a device such as that shown in FIG. 1 to provide a user additional information.

FIG. 10 is a simulated screenshot of an interface that could be displayed by a device such as that shown in FIG. 1 to provide a user physiological information.

FIG. 11 is a simulated screenshot of an interface that could be displayed by a device such as that shown in FIG. 1 to provide a user guidance.

### DETAILED DESCRIPTION

The inventors have conceived of novel technology that, for the purpose of illustration, is disclosed herein as applied in the context of an automated shopping assistant. While the disclosed applications of the inventors' technology satisfy a long-felt but unmet need in the art of automated shopping assistants, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

The technology disclosed herein may be used to provide a tool that informs consumers about which items to buy for their heart's health benefits in a natural and organic setting and to assist consumers in taking a healthier route while being reminded of heart-healthy choices in a retail location. While recommending ingredients and products that are healthier choices is one possible implementation of the disclosed technology, the technology can also be used to provide a next step into the experience in order to assist the consumer in a healthier lifestyle, such as by providing recipes, uses, or other information on a food or product. In some implementations, the technology may guide them throughout the entire shopping experience, concentrating on healthy items for the heart using heart rate monitoring sensors, indoor positioning technology and beacons, combined into a single device that may be attached to a shopping cart and serve as an automated shopping assistant.

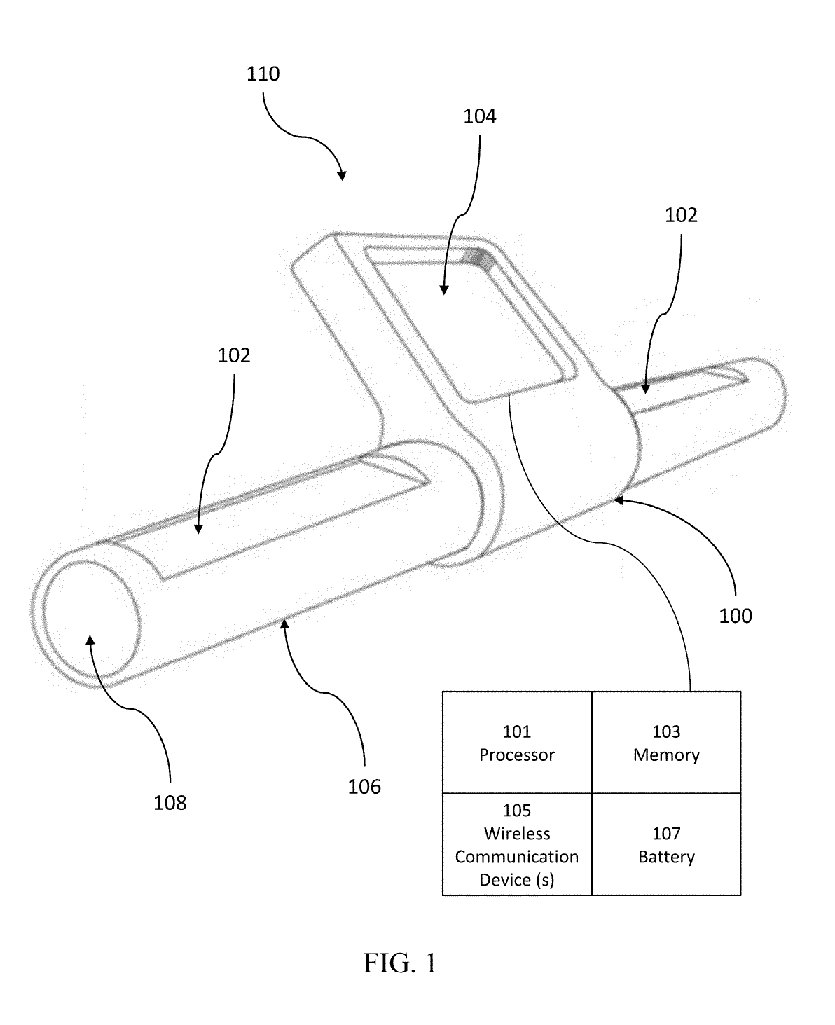

Turning now to the figures, FIG. 1 is a combined perspective and schematic view of an exemplary device for providing information and guidance to a retail shopper. The pictured assistant device (110) comprises a housing (100) which contains a processor (101), a memory (103), one or more wireless communication devices (105), a battery (107), and a touchscreen display (104). The memory (101), processor (103), wireless communication device (105), battery (107) and display may be built into the housing (100) at the time of assembly, but may also be combined into one or more separate devices that may be removable from housing (100). For example, in one embodiment, these components may be combined into a single device such as a tablet mobile computing device which can be securely fixed within the housing (100) and removed for maintenance, replacement, or charging. The processor and memory are configured to provide and receive data from each other and from the wireless communication devices(s) (105), store and manipulate data, render images via the display (104), transmit information to other devices via the wireless communication device(s) (105), and other similar functions. The display (104) may be a variety of display types including a colored display, black and white display, LED, LCD, or plasma display, and may include other features such as a touchscreen or stylus interface, haptic feedback, sound, or other similar features. The battery (107) may be a fixed or removable and rechargeable battery that provides power to the display (104), processor (101), memory (103), wireless communication device(s) (105), and other power-consuming devices that varying implementations might have. The one or more wireless communication devices (105) may include, for example, a Wi-Fi device, a Bluetooth device, an RFID or NFC device, an infrared device, an optical device, a radio device, or any other wireless communication device.

The housing (100) may also include one or more handgrips (106) to provide a shopper with a comfortable location to place their hands when the assistant device (110) is mounted, for example, on a shopping cart, and may also include a cart mount (108) which may allow the assistant device (110) to be integrated with many common shopping cart designs. The handgrips (106) may also include one or more sensor devices (102), which may include, for example, a conductive grip heart rate monitor, a finger clip pulse oximeter, a finger clip blood pressure monitor, or other non-invasive physiological monitors that may easily use a hand, finger, arm or the upper body to provide a source of physiological information. Data generated by the sensor devices (102) may be provided to the processor (101) and memory (103) for manipulation, analysis, display, or other uses.

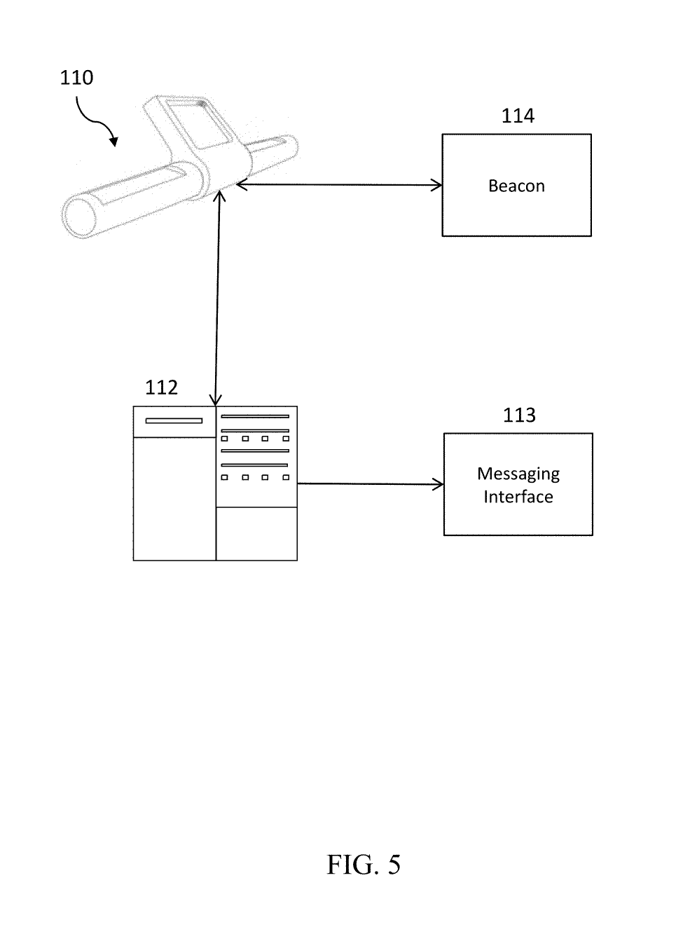

Turning now to FIG. 5, that figure is a schematic diagram of exemplary components in a system for providing information and guidance to a retail shopper. The assistant device (110) may be in communication with a server (112) via a wireless communication device (105). The server (112) may be a computing device located at a retail location, a computing device located at a remote location and accessed via the internet, a physical server, virtual server, distributed server, multiple servers, or other configuration of servers that may be desirable for a particular implementation. The server (112) may comprise a processor, memory, network interface, and other storage devices and databases as may be needed, and may be capable of one or more of receiving, transmitting, processing, analyzing, and manipulating data. The server (112) and the assistant device (110) may be in communication with each other via Wi-Fi, Bluetooth, or another wireless communication method. For example, in some implementations, the assistant device (110) may connect to a local wireless network at a retail location via a Wi-Fi device in order to provide and receive data from a server (112), which may be located at that retail location and connected to the same local network.

A database of the server (112) may serve as a repository for food, ingredient, and product information, which may include, for example, nutritional information, location information, health information, recipes, selection guides, video, audio, user information for individual users and groups of users, physiological information such as average heart rate, weight, blood pressure, blood oxygen levels and other information across various demographics, and other similar information that may desirable be displayed via the assistant device (110). A database of the server (112) may also store configurations specific to a particular assistant device (110), user, or physical location in which the system is implemented, which may include, for example, a physical location map, a beacon location map, beacon information indicating the path that a particular assistant device (110) or user has taken through a store, user information identifying a user, describing their past use of the device, or indicating ways in which they prefer to be contacted or receive additional information, and assistant (110) configurations which may be loaded to an assistant (110) in order to cause it to provide information and advice appropriate for a particular retail location or user. Other types of information stored by a database of the server (112) will be apparent to those of ordinary skill in the art in light of the disclosure herein. It should further be understood that a server (112) database may be a device or storage local to the server (112), or at a remote location that the server (112) is in communication with, such as a cloud storage service or repository. Data stored in one or more databases may be accessed by the assistant device (110) on demand in some embodiments, but it should also be noted that the assistant device (110) may in some embodiments regularly access information in the database and download it or transfer it to a removable memory in bulk to be transferred and stored locally to the assistant device (110).

The server (112) may also include or be in communication with a messaging interface (113), which may variably be configured to transmit communications via email, SMS, automated phone call, social media, or other communication channel. The messaging interface (113) may be used by the server (112) to provide additional requested information, recipes, and user data to a user of the assistant device (110).

The assistant device (110) may also be in communication with one or more beacons (114) via a wireless communication device (105). In some embodiments a beacon (114) may comprise a housing that can be affixed to a surface, and the housing may contain some simple components such as a microprocessor, memory, low energy Bluetooth transceiver, and a battery. However, any device having similar capabilities such as a computer, smartphone, tablet, or other device having some processing power and Bluetooth capability or other wireless communication capability could act as a beacon (114). A beacon (114) may be configured to detect or be detected by other devices that it may communicate with inside a configured proximity. For example, in some embodiments a beacon equipped with a low energy Bluetooth transceiver may detect or may be detected by an assistant device (110) having a Bluetooth transceiver, and a connection may be established between the devices so that information may be exchanged between the beacon (114) and the assistant device (110).

Information exchanged could include, for example, a unique identifier or other unique information that could be used to determine a beacon's physical location within a retail space. Such a unique identifier could be, for example, a coordinate indicating a physical location within a custom coordinate system associated with a retail space, a device identifier or serial number that may checked against a table of device identifiers stored on an assistant device (110) or server (112) in order to determine a physical location, or other similar methods of determining a physical location from a machine-readable, unique identifier. A beacon's (114) range for connecting to and exchanging information with an assistant device (110) may vary depending upon such factors as transceiver power, antenna configuration, placement, and other factors, and may range from several centimeters to tens of meters. A desirable range for a beacon (114) included in the disclosed system and technology may depend upon a particular implementation and layout of a retail space, but a range of 2-6 meters may be considered one example of an appropriate range for a beacon (114) to connect to an assistant device (110) and determine the beacon's (114) location.

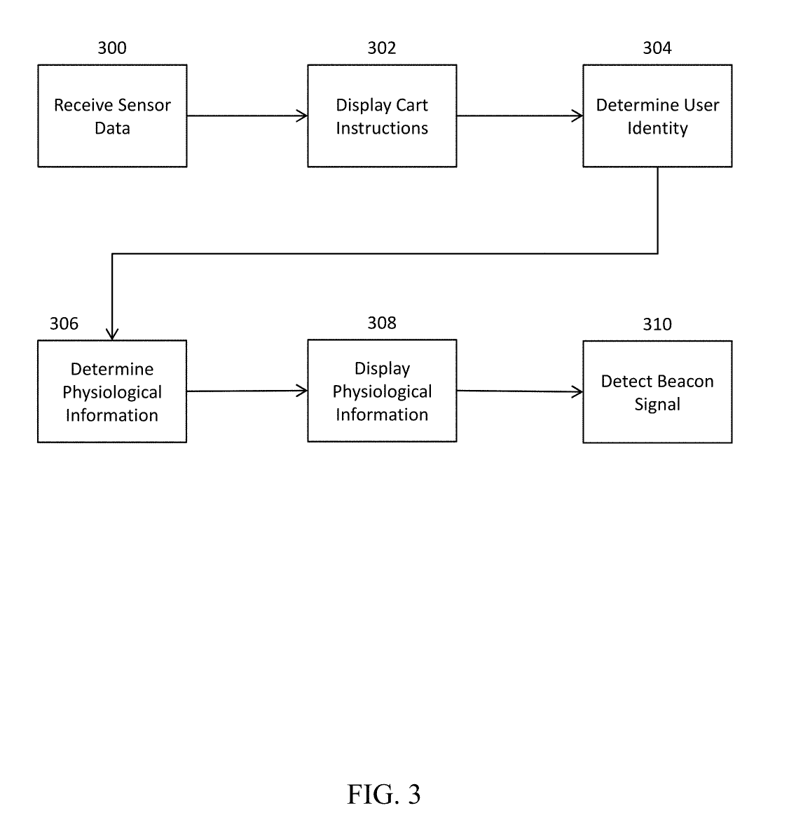

Turning now to FIG. 3, that figure shows a set of exemplary steps that may be performed by a system such as that shown in FIG. 5 in order to prepare an assistant device (110) for use. When not in use, a display (104) of the assistant device (110) may display instructions for a user that instruct the user to grip the handgrips or otherwise interact with the sensors (102). In some embodiments, the display (104) may initially be turned off, and a motion detection sensor (102) of the assistant device (110) may detect motion indicating that the assistant device (110) is being moved by a user and cause the display (104) to power on and display instructions. When a user interacts with the sensors (102), which could include gripping a metal plate of a conductive heart rate monitor, placing a finger in a finger clip, or other interactions, physiological data generated by the sensor (102) may be received (300) by the assistant device (110). The assistant device (110) may display (302) additional instructions when a user is detected in this manner, which could include explanations of how the system works, how to interact with the system, instructions for optimizing accuracy of the sensors (102), or other information. In one embodiment, the displayed (302) instructions may instruct a user to maintain a firm grip on a conductive heart rate sensor (102) so that accurate heart rate information may be generated by the sensor (102), and may also instruct a user to proceed to a certain physical location, aisle, or feature within a retail space.

The assistant device (304) may also, in some embodiments, determine (304) a user identity. Determining (304) a user identity could include personally identifying a user, but could also include simply identifying them as an anonymous user based upon, for example, feedback from a sensor (102). Determining (304) a user identity could include a variety of scenarios. In one embodiment, a user may provide basic information such as gender, age, height, or weight, which may be used to provide more accurate information regarding heart rate, blood pressure, blood oxygen levels, or other physiological information and whether such data is normal or abnormal for a particular user's gender, age, height, or weight. In another embodiment, a user may provide unique or semi-unique information such as a phone number, email address, username, or user identification number which may be used to identify the user and retrieve additional stored information from the server (112). In another embodiment, a user may use a personal device such as a smartphone to interact with a wireless communication device (105) of the assistant device (110), such as a Bluetooth transceiver or NFC/RFID reader, in order to exchange unique identifying information that may allow the assistant device (110) to identify the user based upon records stored on the server (112). In yet other embodiments, the assistant device (110) may not personally identify the user at all, and may simply create a temporary or permanent identifier for the user that may be used to associate information with the user for the current session while the actual user remains anonymous. The particular method of identifying (304) a user will vary by embodiment, and may depend on such factors as intended ease of use, desired level of privacy for users, desired cost, and other factors.

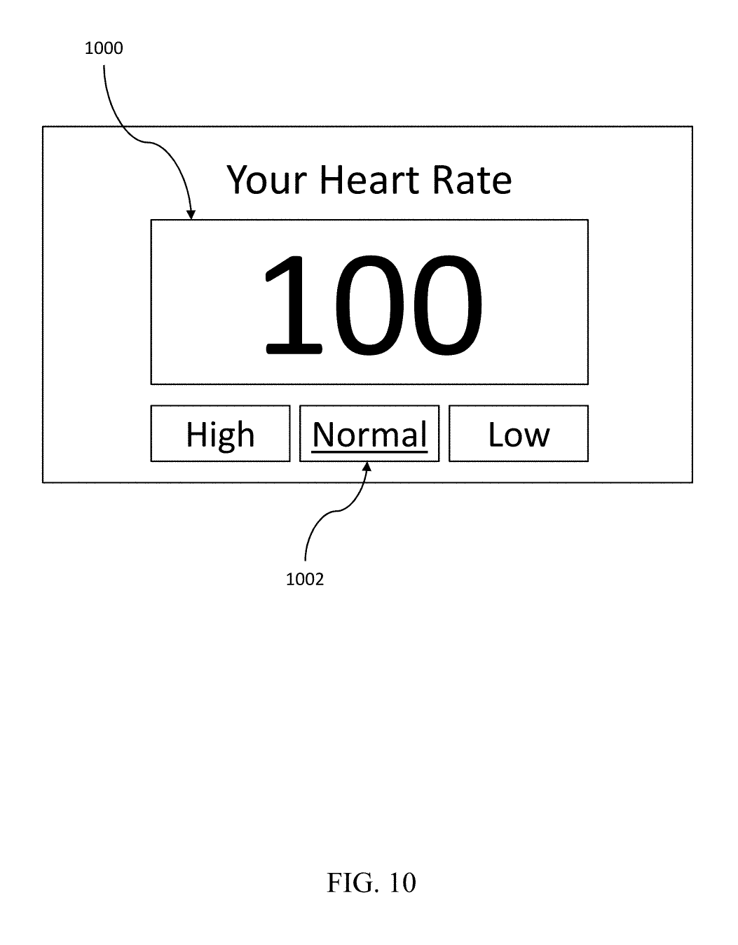

The assistant device (110) may also determine (306) and display (308) physiological information for the user. This could include information generated by a sensor (102) such as a heart rate monitor or finger clip monitor, which could be received by the processor (101), manipulated or interpreted if necessary, and displayed via the display (104) in a human-readable format. Such information may be displayed numerically (e.g., “100 bpm”), textually (e.g., “high heart rate”), visually (e.g., red circle or frowning face for abnormal, green circle or smiling face for normal), or other displayable indicators. In some embodiments, such information could also be spoken aloud via a speaker or other audio device. FIG. 10 shows one exemplary interface that may be displayed by the assistant device (110), which may show, for example, the physiological information (1000) as well as additional information (1002) such as whether the physiological information (1000) is normal or abnormal. The assistant device (110) may also enable one or more wireless communication devices (105) that may exchange information with the server (112) or a beacon (114), or it may begin to actively search for or detect (310) beacons (114).

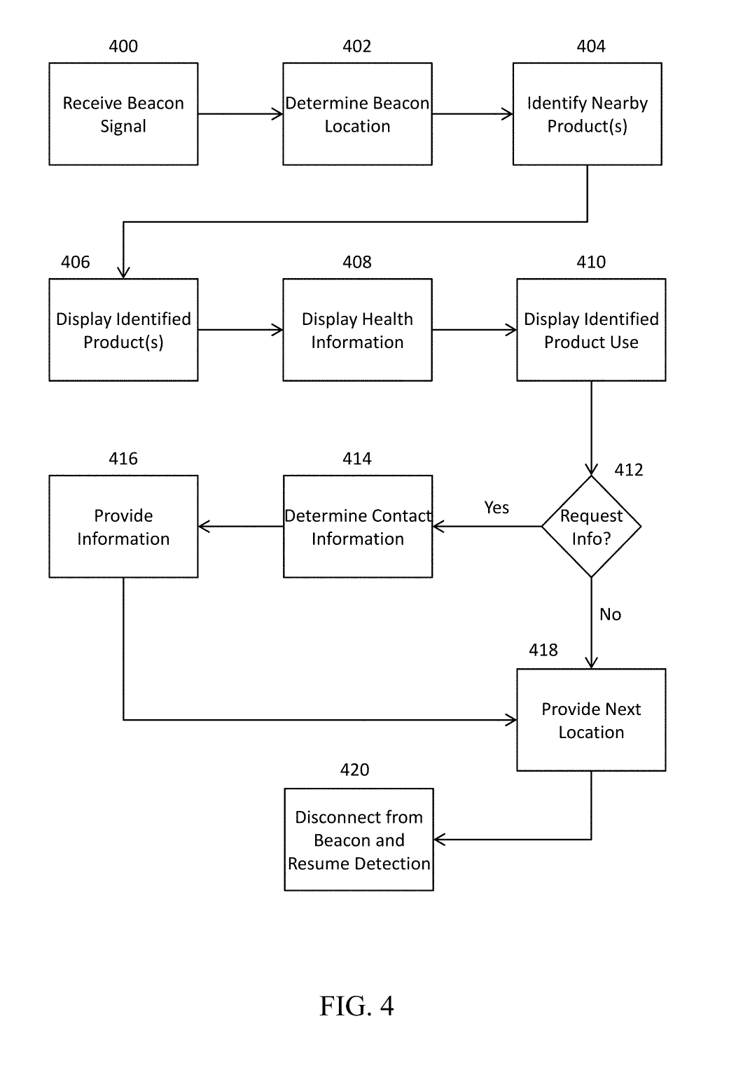

Turning now to FIG. 4, that figure shows an exemplary set of steps that a system such as that shown in FIG. 5 may perform to provide information and guidance based upon a beacon (114) connection. When a beacon (114) is within range of the assistant device (110), the devices may connect and exchange information such that the assistant device (110) may receive (400) data from the beacon (114). Received (400) data may include a location identifier, a location coordinate, a device identifier, or other unique or semi-unique information that may be included in a machine readable code and used, by itself or in conjunction with data from a database, and characteristics of the received signal to uniquely identify the location of the connected beacon (114). Once a beacon location has been determined, one or more nearby products may be identified (404). Nearby products may be determined based upon their real world proximity to the beacon in a dynamic way, such as by querying a retailer database to determine which products are shelved in the same aisle or within a certain proximity of a particular beacon and are also flagged as being associated with health information or guidance, or each beacon could be associated with a set of products that have been determined to be near that beacon. For example, in one embodiment, connecting to a beacon in a butcher section of a grocery store may cause the system to identify (404) chicken breast or lean beef as a nearby product associated with health information or guidance, based upon a database record or other data association that identifies that beacon or region within the store as being associated directly or indirectly with a product record for chicken breast or lean beef.

Product identification (404) may also be based in part upon other factors such as, for example, physiological information gathered from a sensor (102), a set of preferences provided by the user in response to queries displayed by the assistance device (110), a set of preferences stored in a database and associated with a unique identifier of the user, or a set of user purchase history stored in a database and associated with a unique identifier of the user. For example, where physiological information gathered from a sensor (102) is used to help in selected or identifying (404) products, a user's heart rate may be measured by the sensor (102) and varying products may be selected for display based upon whether the heart rate is normal or abnormal. To continue this example, where the user's heart rate is normal, a product may be identified from a set of products containing an unrestricted variety of foods. Where the user's heart rate is abnormal, such as where it may be too high for a person strolling through a grocery store, a product may be identified from a restricted set of products containing foods that are low in sodium, low in sugar, low in fat, or otherwise more closely associated with having a greater impact on heart health than one or more products in the unrestricted product set.

Product identification (404) that is partly based upon user preferences provided in response to a query by the assistant device (110) may include, for example, displaying a query to a user that solicits some type of dietary preference, such as whether the user is a vegetarian, vegan, has certain allergies, prefers fish or chicken, or other queries that might be used to tailor products display to the user and avoid suggesting options that they have no intention of choosing. Such queries could be display intermittently during transit through the retail space, or could be coupled with the display (406) of an identified (404) product. For example, when chicken breast is identified (404) and displayed (406), the assistant device (110) could also display a query such as “Are you vegetarian?” If the user interacts with the touchscreen display (104) to indicate that they are vegetarian, the assistant device (110) may cease displaying (406) chicken breast and instead identify a new product from a set of vegetarian products, such as multi grain rice, to be displayed (406). Such preferences could be retained by the assistant device (110) and used for future selection and identification of products (404) until the assistant device (110) is returned to its origin, a beacon connection indicates that the assistant device (110) is passing through a checkout lane, or a sensor (102) indicates that the user is no longer in contact with or no longer possesses the assistant device (110).

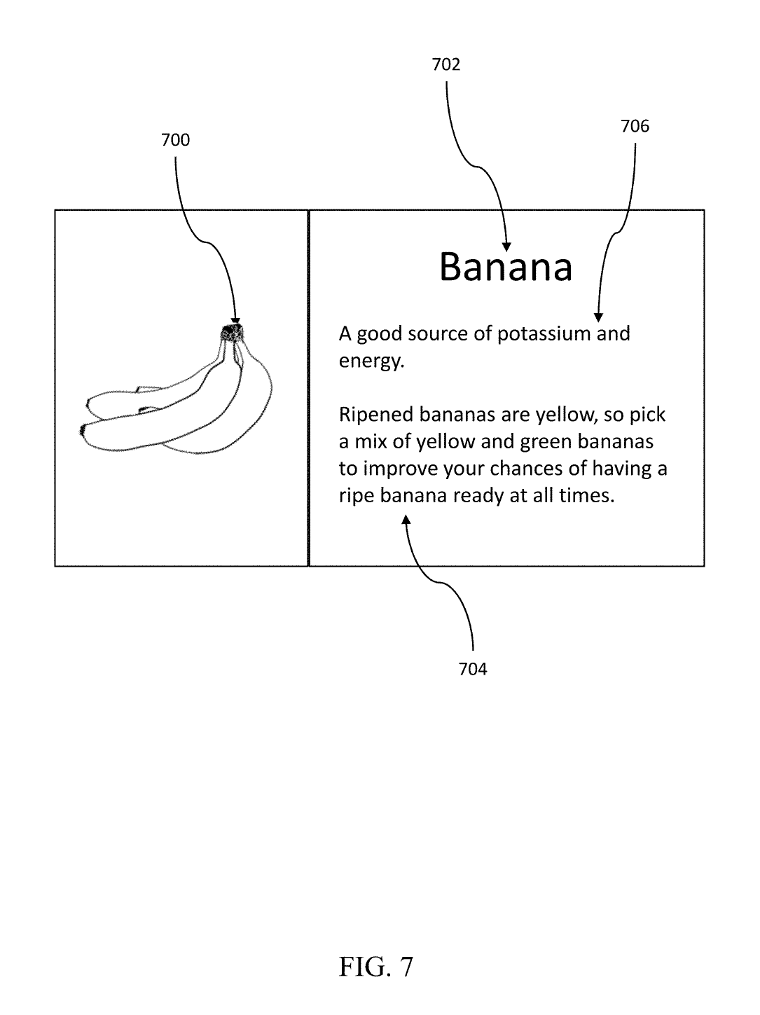

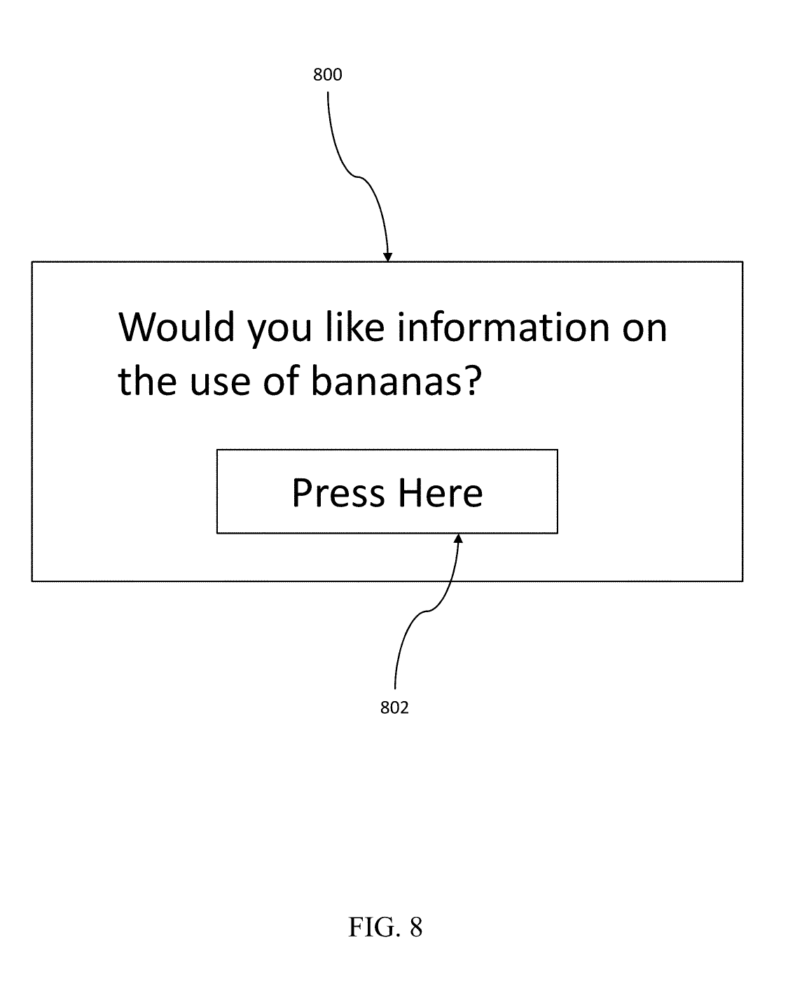

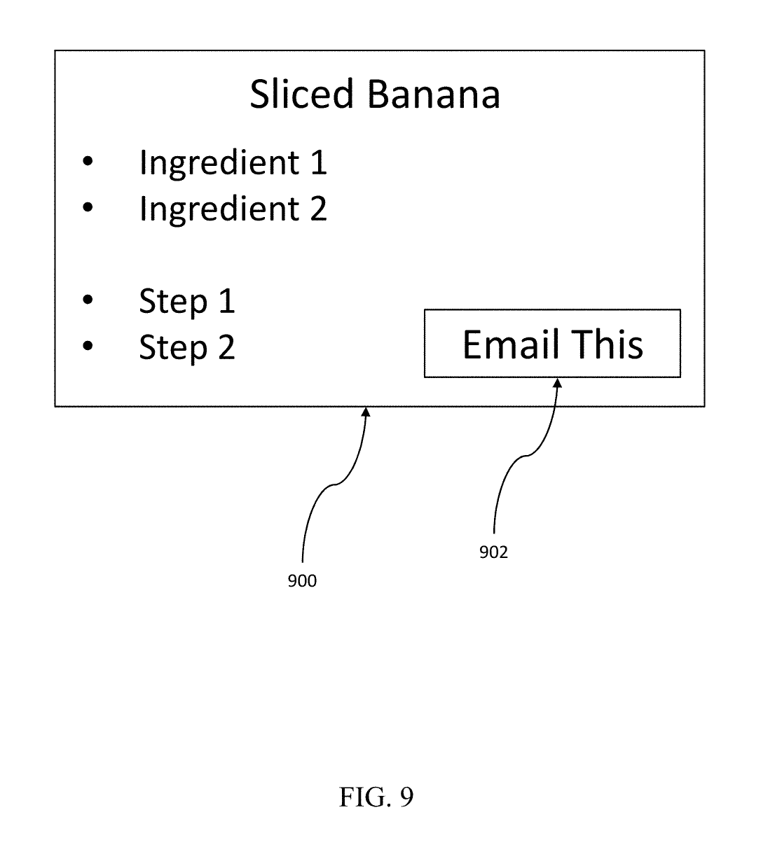

The assistant device (110) may also display (406) one or more of the identified (404) products via the display (104), which may include showing images of the product, showing a location of the product on a shelf, in a bin, or another product display, or showing other information to help in locating and choosing the product. FIG. 7 shows an exemplary interface that may be displayed via the assistant device (110), which shows, for example, an image of the product (700) that may be used to help locate the product on a shelf or display, a product description (702), and product information (704) to help in selecting a product. The assistant device (110) may also display (408) health information (706), which may explain why the product is being featured or display on the assistant device (110) or why it is considered a product associated with health information and guidance. The assistant device may also display (410) uses or recipes for the product. This could occur automatically, or could occur in response to an input received via the assistant device (110) touch screen or other interface. FIG. 8 shows an example of an interface that may be displayed to a user to prompt (800) a user to provide a request (802) to display (410) uses or recipes for the product. FIG. 9 shows an example of an interface that may be displayed to a user to provide additional information (900) on uses of the product. Such an interface may also include a messaging interface element (902) that the user may interact with to cause the system to provide one or more pieces of information via the messaging interface (113). When interacted with, such an interface element (902) may allow a user to receive product information (700, 702, 704, 706) and product use information (900) via email, SMS, phone call, social media, or other communications channel.

If a user interacts with the interface element (902), the assistant device may determine (414) the contact information or communication channel that the user wishes to receive the information through. Such a determination (414) may be made in several ways. In one embodiment, in a system which identifies (304) a user uniquely, a user's email address, phone number, social media accounts or other contact information and communication preferences may already be readily available within a database or other data record. In other embodiments such as systems that minimally identify (304) a user, the assistant device (110) may instead display a request for contact information to a user and allow the user to enter the requested information via a touchscreen display or other interface so that a user's email address or telephone number may be captured for one-time use. Once contact information is received from a user or determined based upon pre-existing records, the requested information may be provided (416) to the requester via the configured channel at the provided point of contact.

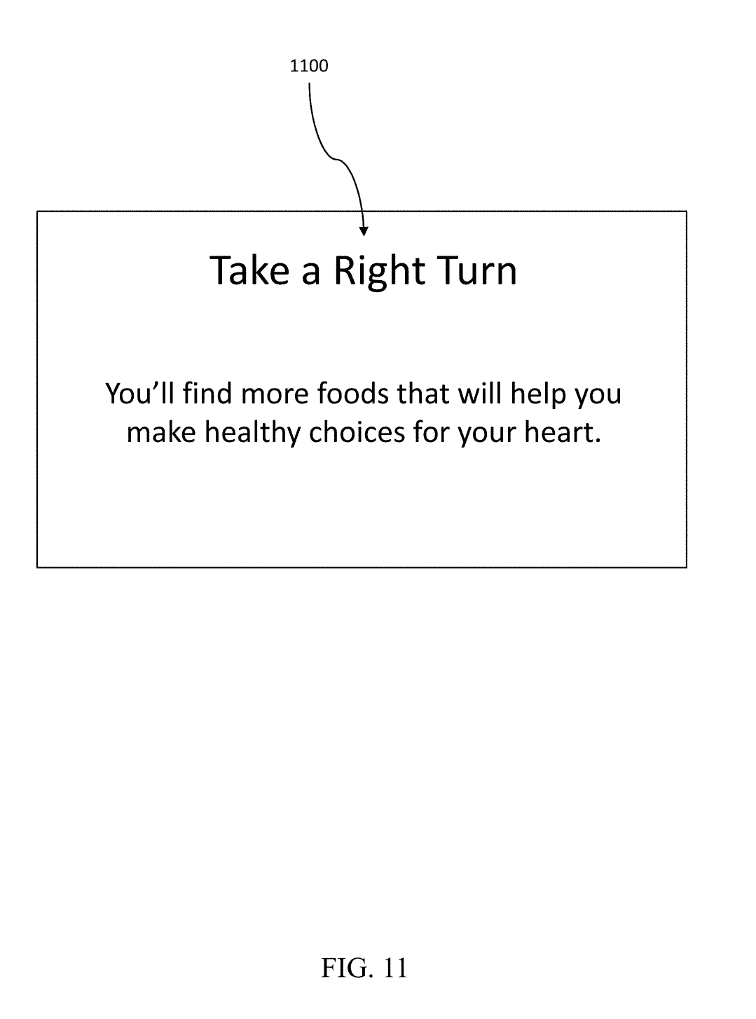

In some embodiments, after the user either requests or refuses additional information (412), the assistant device (110) may determine and provide (418) a next location that the user should proceed to via the display (104). FIG. 11 shows an exemplary interface that may be displayed via the assistant device (110) to provide (418) guidance (1100) to a next location. Once the desired information has been provided or after a user has left the proximity of a connected beacon, the beacon (114) and assistant device (110) may disconnect (420) so that the assistant device (110) may begin to actively listen for other beacons (114).

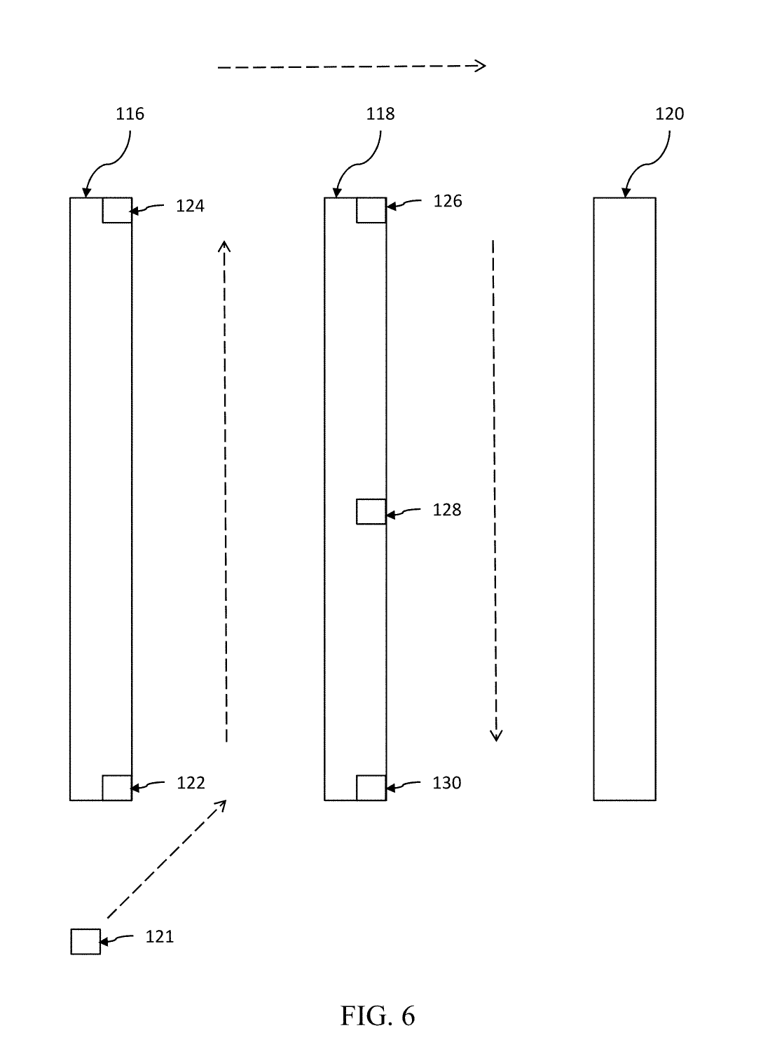

FIG. 6 shows one example of an environment in which the above disclosed technology may be implemented to provide guidance and information to a user. Such an environment may have several areas or aisles (116, 118, 120) that store and display a variety of retail products. A first aisle (116) may have a beacon (122) at a first end and a beacon (124) at a second end. A second aisle (118) may have a beacons at a first end (126), at the middle (128), and at a second end (130). Additionally, a first beacon (121) may be placed near a cart storage area where a number of carts with attached assistant devices (110) are stored. A user may obtain a cart-mounted assistant device (110) nearby a first beacon (121), and perform one or more of the steps of FIG. 3 in order to engage the user and provide (308) health information and further instructions on the use of the assistant device (110). After connecting with the first beacon (121), the assistant device (110) may determine that the user is near the cart storage area and instruct them to proceed to a first aisle (116). A beacon (122) at the entrance of this aisle may connect to the assistant device (110) and cause the assistant device to determine that the user has arrived at the first aisle (116), and to display one or more products or healthy foods that are available within the first aisle (116) according to one or more of the steps of FIG. 4. As the user leaves the aisle, the assistant device (110) will connect to one of the beacons (122, 124) and allow the assistant device (110) to determine both that the user is leaving the first aisle (116) as well as the user location relative to the second aisle (118). This may allow the assistant device (110) to provide specific guidance on proceeding to the second aisle (118) if more products or foods are located in the second aisle (118).

For example, a user exiting the first aisle (116) may pass by the exit beacon (124) of the first aisle (116), causing the assistant device (110) to display the message “Head to aisle 2 for more heart healthy foods.” As the user reaches the second aisle (118) and passes the entry beacon (126), it may cause the assistant device (110) to display an interface such as that shown in FIG. 11 instructing the user to turn right, or left, if entering closer to a different beacon (130). Upon reaching the mid-aisle beacon (128) and connecting, the assistant device (110) may display a message identifying one or more products located in that area that may be associated with health information or guidance. In addition to instructing users to proceed to a certain aisle, or turn down a certain aisle, each beacon (122, 124, 126, 128, 130) may also provide product information according to one or more of the steps of FIG. 4 for products that may be in that aisle, on endcaps, or otherwise displayed along the route that is shown in FIG. 6. Operating in the manner disclosed above and shown in FIG. 6, beacon placement and association with products and other information can be used to guide a shopper along any desired route via the assistant device (110), with one or more products, foods, or recipes featured throughout the route.

While the embodiments illustrated above determine the region of the store in which assistant device (110) is operating by detecting which beacons (114) are near enough for the assistant device (110) to receive their signal, other embodiments will replace or augment that technique by determining the distance between assistant device (110) and each detected beacon (114). In some of these embodiments, a more precise location (as accurate as the margin of error of the distance measurement and location specification for the relevant beacon (114) will allow) can be determined using triangulation techniques as will occur to those skilled in the art in view of this disclosure.

Further variations on, features for, and applications of the inventor's technology will be apparent to, and could be practiced without undue experimentation by, those of ordinary skill in the art in light of this disclosure. Accordingly, the protection accorded by this document, or by any related document, should not be limited to the material explicitly disclosed herein, the protection should be understood to be defined by the claims, if any, set forth herein or in the relevant related document when the terms in those claims which are listed below under the label “Explicit Definitions” are given the explicit definitions set forth therein, and the remaining terms are given their broadest reasonable interpretation as shown by a general purpose dictionary. To the extent that the interpretation which would be given to such claims based on the above disclosure is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in the specification or priority documents shall have no effect. For flowcharts or step diagrams that are shown or described as being serial, it should be understood that the steps may instead be performed in parallel unless such an implementation is specifically disclaimed or inherently impossible due to stated dependencies. Likewise, any flowchart or step diagram that is shown or described as being parallel may instead be performed in series or in sequence, unless such an implementation is specifically disclaimed or inherently impossible due to stated dependencies. When used in the figures and written description the terms select, selection, selected, and other variations may not refer to specific technologies, database syntax, or programming languages, and instead refer to a more general process of querying, searching, or identifying a matching or partially matching data set from a larger pool of data.

### Explicit Definitions

When appearing in the claims, a statement that something is “based on” something else should be understood to mean that something is determined at least in part by the thing that it is indicated as being “based on.” When something is required to be completely determined by a thing, it will be described as being “based exclusively on” the thing.

When used in the claims, “configured” should be understood to mean that the thing “configured” is adapted, designed or modified for a specific purpose. An example of “configuring” in the context of computers is to provide a computer with specific data (which may include instructions) which can be used in performing the specific acts the computer is being “configured” to do. For example, installing Microsoft® WORD on a computer “configures” that computer to function as a word processor, which it does by using the instructions for Microsoft WORD in combination with other inputs, such as an operating system, and various peripherals (e.g., a keyboard, monitor, etc).

When used in the claims, “determining” should be understood to refer to generating, selecting, defining, calculating or otherwise specifying something. For example, to obtain an output as the result of analysis would be an example of “determining” that output. As a second example, to choose a response from a list of possible responses would be a method of “determining” a response. As a third example, to identify data received from an external source (e.g., a microphone) as being a thing would be an example of “determining” the thing.

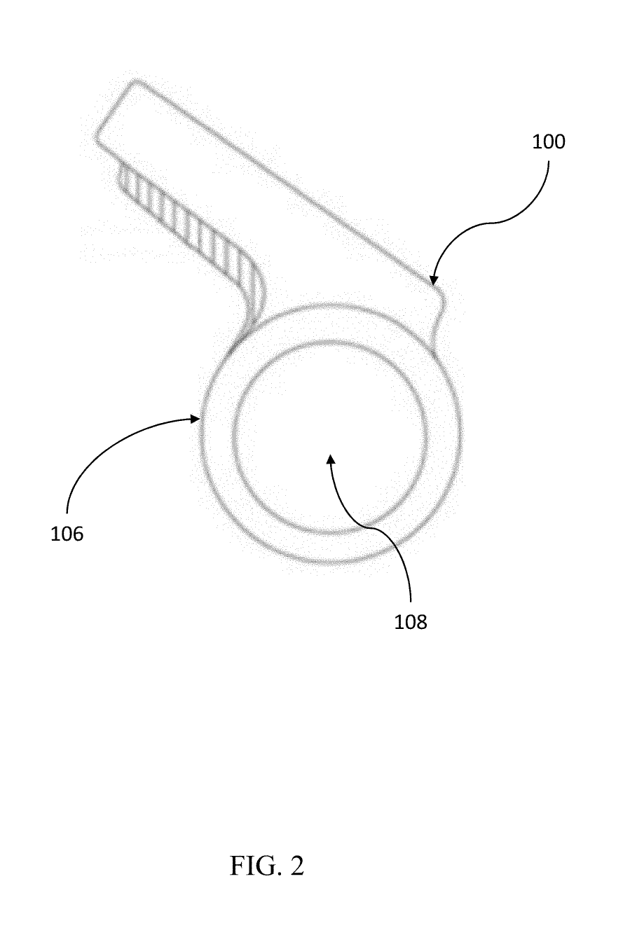

When used in the claims, a “a means for guiding a user through two or more locations in a retail space while displaying product information for a product associated with each location” should be understood as a limitation set forth in the form of a means for performing a specified function as provided for in the sixth paragraph of 35 U.S.C. § 112 in which the specified function is “guiding a user through two or more locations in a retail space while displaying product information for a product associated with each location” and the corresponding structure is a system having physical components such as a personal assistant device with a processor and memory described in paragraphs [0020]-[0026] and shown in FIGS. 1, 2, and 5 where the processor and memory are programmed to receive information from a beacon placed in a retail space and provide examples of nearby foods as well as instructions for proceeding to a subsequent beacon (examples provided in FIGS. 4 and 6-11 and paragraphs [0030]-[0039]).

When used in the claims, a “set” should be understood to refer to a collection containing zero or more objects of the type that it refers to. So, for example, a “set of integers” describes an object configured to contain an integer value, which includes an object that contains multiple integer values, an object that contains only a single integer value, and an object that contains no integer value whatsoever.

What is claimed is:

1. A system for providing information and guidance in a retail shopping space, comprising:
a. an assistant device comprising a processor, a memory, a first wireless communication device, a display, and a sensor;
b. a set of beacons, including a first beacon located at a first location, each beacon of the set of beacons comprising a beacon communication device and a battery;
wherein the processor is configured to execute a set of instructions to cause the assistant device to:
i. identify a user who is near to the assistant device;
ii. determine a physiological characteristic for the user based upon a set of physiological information generated by the sensor;
iii. display the physiological characteristic;
iv. determine that the first beacon is within a connection range of the assistant device and establish at least a first communication channel with the first beacon via the first wireless communication device and the first beacon's beacon communication device;
v. receive a location identifier from the first beacon through the first communication channel;
vi. select a first set of product information based on the location identifier; and
vii. display the first set of product information via the display.

2. The system of claim 1, wherein:
a. the first wireless communication device is a Bluetooth transceiver;
b. the beacon communication device is a Bluetooth transceiver;
c. the first location is a shelf in an aisle of a retail location;
d. the assistant device is fixed to a shopping cart; and
e. the first set of product information comprises:
i. a food description;
ii. a food recipe;
iii. a food health impact description;
iv. a food image;
v. a product location; and
vi a set of instructions for reaching the product location from the first location.

3. The system of claim 1, further comprising a product information server comprising a server communication device, wherein:
a. the assistant device further comprises a second wireless communication device;
b. the first set of product information is stored on the product information server; and
c. the first set of product information is provided to the assistant device via the second wireless communication device.

4. The system of claim 1, wherein the processor is further configured to execute instructions to cause the assistant device to:
a. receive a request for product information;
b. determine a contact channel for the user;
c. provide the first set of product information to the user via the contact channel;
wherein:
i. the contact channel comprises at least one of an email address, a telephone address, and a social media account; and
ii. the instructions to determine the contact channel comprise instructions to:
A. receive the contact channel via a user interface of the assistant device; or
B. use a unique user identifier to identify the contact channel associated with the unique user identifier.

5. The system of claim 1, wherein the processor is further configured to execute instructions to cause the assistant device to:
a. identify a second beacon in the set of beacons, where the second beacon is at a second location;
b. identify a set of directions associated with the first beacon and the second beacon, wherein the set of directions comprises one or more instructions for proceeding from the first location to the second location; and
c. display the set of directions on the display.

6. The system of claim 5, wherein the processor is further configured to execute instructions to cause the assistant device to:
a. determine that the second beacon is within the connection range of the assistant device and establish at least a second communication channel with the second beacon via the first wireless communication device and the second beacon's beacon communication device;
b. receive a second location identifier from the second beacon through the second communication channel;
c. select a second set of product information based on the physiological information and the second location identifier; and
d. display the second set of product information via the display.

7. The system of claim 1, wherein the set instructions to display the first set of product information via the display comprise instructions to:
a. display a product description;
b. display a product health impact;
c. display a product selection guide; and
c. display a recipe request interface element.

8. The system of claim 7, wherein the set of instructions to display the first set of product information via the display comprise instructions to receive a recipe request and, in response:
a. display a set of recipe ingredients;
b. display a set of recipe steps; and
c. display a recipe image on the display.

9. The system of claim 1, wherein the set of instructions to display the physiological characteristic comprise instructions to:
a. display a numerical representation of the physiological characteristic; and
b. display a textual representation of the physiological characteristic relative to an ideal value or range for the physiological characteristic.

10. The system of claim 9, wherein:
a. the numerical representation of the physiological characteristic is a number of beats per minute of a heart; and
b. the textual representation of the physiological characteristic is a description that indicates the numerical representation of the physiological character is considered high, low, or normal.

11. The system of claim 1, wherein the assistant device is fixed to a shopping cart, and wherein the assistant device further comprises a handgrip adapted to allow the user to push the shopping cart by the handgrip.

12. The system of claim 11, wherein the sensor is a heart rate monitor, and wherein the heart rate monitor is situated on the surface of the handgrip and adapted to be gripped by the user when the shopping cart is pushed.

13. The system of claim 1, wherein the first set of product information describes a product that is located within a shopping aisle that is associated with the first beacon.

14. The system of claim 1, wherein the first set of product information is selected based on:
a. the location identifier; and
b. the physiological characteristic.

15. The system of claim 1, wherein the processor is further configured to execute a set of instructions to cause the assistant device to:
a. display a product preference query via the display; and
b. receive a product preference filter via a user interface of the assistant device;
wherein the first set of product information is selected based on:
a. the location identifier; and
b. the product preference filter.

16. A method for providing information and guidance in a retail shopping space, comprising the steps:
a. identifying a user who is near to an assistant device;
b. determining a physiological characteristic for the user based upon a set of physiological information generated by a sensor of the assistant device;
c. displaying the physiological characteristic via a display of the assistant device;
d. determining that a first beacon of a set of beacons is within a connection range of the assistant device and establish at least a first communication channel with the first beacon via a first wireless communication device of the assistant device and a beacon communication device of the first beacon;
e. receiving a location identifier from the first beacon through the first communication channel;
f. selecting a first set of product information based on the location identifier; and
g. displaying the first set of product information via the display.

17. The method of claim 16, further comprising the steps:
a. receiving a request for product information;
b. receiving a contact channel for the user via a user interface of the assistant device; and
c. providing the first set of product information to the user via the contact channel;
wherein the contact channel comprises at least one of an email address, a telephone address, and a social media account.

18. The method of claim 16, further comprising the steps:
a. identifying a second beacon in the set of beacons, where the second beacon is at a second location;
b. identifying a set of directions associated with the first beacon and the second beacon, wherein the set of directions comprises one or more instructions for proceeding from the first location to the second location; and
c. displaying the set of directions on the display.

19. The method of claim 18, further comprising the steps:
a. determining that the second beacon is within the connection range of the assistant device and establishing at least a second communication channel with the second beacon via the first wireless communication device and the second beacon's beacon communication device;
b. receiving a second location identifier from the second beacon through the second communication channel;
c. selecting a second set of product information based on the physiological information and the second location identifier; and
d. displaying the second set of product information via the display.

20. A system for providing information and guidance in a retail shopping space, comprising:
a. a set of beacons, including a first beacon located at a first location and a second beacon located at a second location, each beacon of the set of beacons comprising a beacon communication device and a battery; and
b. a means for guiding a user through two or more locations in a retail space while displaying product information for a product associated with each location.
